(19) United States
(12) Patent Application Publication
(10) Pub. No.: US 2006/0143091 A1
(43) Pub. Date: Jun. 29, 2006

(54) Shopping assistant method and system

(75) Inventors: Chii-Yah Yuan, Hsinchu City (TW); Yi-Fei Luo, Jhudong Township (TW); Hon-Yue Chou, Taipei City (TW); Teh-Chang Wu, Yonghe City (TW); Leii H. Chang, Cyonglin Township (TW); Chuan-Shun Wu, Gueiren Township (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsinchu (TW)

(21) Appl. No.: 11/175,151

(22) Filed: Jul. 7, 2005

(30) Foreign Application Priority Data
Dec. 27, 2004 (TW) 093140785

(51) Int. Cl. G06Q 30/00

(52) U.S. Cl. 705/26

(57) ABSTRACT

A shopping assistant method and system provides a consumer with a mobile terminal in a shopping mall as a shopping assistant. The consumer can input a shopping list to the mobile terminal in advance and login at an entrance of the shopping mall in a wireless way for sending the shopping list to a remote server in the shopping mall. The remote server finds goods in the shopping list from its database that have identical names and other goods having information that meets with a pre-stored preference condition, and then sends the information found to the mobile terminal for display. Accordingly, the consumer can conveniently compare prices among numerous goods and quickly get the desired goods, or the closest ones. When the consumer finishes shopping, the remote server further deducts the amount from a personal financial account so as to complete an e-commerce.

### BACKGROUND OF THE INVENTION

1. Field of the Invention

The invention relates to a shopping assistant method and system and, more particularly, to a shopping assistant method and system using a wireless communication technology in a shopping mall.

2. Description of Related Art

Consumer needs create shopping behaviors. Generally, required quantities and purchase frequencies are changed with types of goods and consumer preferences and behaviors. When shopping, customers usually have different habits for remembering their shopping list, for example, writing down on a paper or memorizing it. But in many cases, certain customers may shop again because they skip some items on the list.

Current shopping malls typically occupy a wide area to offer numerous goods, which are not easy to be viewed completely at a glance. In addition, different shopping malls may have different promotions for different goods. In this case, a consumer usually have to spend much time to compare prices among a lot of goods in advance in order to select the best from the presented goods, which may be a trouble for both the consumer and a respective seller, even lose the promotion effect.

Therefore, it is desirable to provide an improved method to mitigate and/or obviate the aforementioned problems.

### SUMMARY OF THE INVENTION

The object of the invention is to provide a shopping assistant method, which is used in a shopping mall that sells plural goods.

To achieve the object, a shopping assistant method is provided, which is used in a shopping mall that sells plural goods. The method includes the steps: (A) providing a mobile terminal to be portable in a shopping mall; (B) establishing a shopping list in the mobile terminal, the shopping list having goods names to be purchased; (C) sending the shopping list from the mobile terminal to a remote server with a database, the database storing a plurality of goods information respectively associated with selling goods available in the shopping mall, each goods information having a goods name, a price and a plurality of detail data; (D) searching the database by the remote server for finding each goods information that has a goods name identical to one of the goods names in the shopping list and at least one detail data meeting with a pre-stored preference condition, thereby forming a recommendable shopping list to be sent to the mobile terminal for displaying at least the identical goods names and their respective prices contained in the recommendable shopping list.

Thus, a consumer in shopping can establish the shopping list in advance. Also, a seller can supply identical goods or provide similar ones and associated data to the consumer according to consumer preferences or habits, so as to offer the consumer convenient price comparison or more type choices.

The method further includes the steps: (E) confirming picked goods and inputting a personal financial account by the consumer via the mobile terminal, thereby obtaining a total amount for a payment of the picked goods; (F) using the mobile terminal to send the total amount and the personal financial account to the remote server; and (G) using the remote server to deduct the total amount from the personal financial account through a banking network. Obviously, the invention combines with a backend account transfer/deduction mechanism to offer the consumer a convenient shopping and auto-payment banking service.

The personal financial account can be a consumer's credit account, e-wallet account or e-coupon number that can identify the consumer.

The information stored in the database further has stored locations of the selling goods available in the shopping mall, which can also be displayed on the mobile terminal in the step (D).

The mobile terminal can be a personal digital assistant (PDA), mobile phone, smart phone or web pad in wired or wireless way to transfer data to the remote server. The web pad is an electronic device that has a display and an I/O for wireless online access.

Each selling goods available in the shopping mall has an electronic identification label to store corresponding name, price and at least one detail data. The mobile terminal further includes a reader and pre-stores another preference condition. Further, a step D1 is included before the step (D), which the reader of the mobile terminal reads an electronic identification label of a current selling goods in a current goods shelve and matches its detail data with the another preference condition to accordingly display all content of the electronic identification label of the current selling goods in the current goods shelve, thereby helping the consumer to determine where the current goods shelve is located in the shopping mall and understand the content of the current selling goods.

The electronic identification label can be a radio frequency electronic identification (RFID) label, bar code, magnetic stripe, IC card, or other equivalent electronic identification label.

The invention provides a shopping assistant system, which is used in a shopping mall that sells plural goods. The system includes at least one mobile terminal and a remote server. The mobile terminal has a microprocessor, a display and a first data communication device. A shopping list with goods names to be purchased is established in the mobile terminal via an input device. The remote server includes a database and a second data communication device. The database stores a plurality of information associated with selling goods available in the shopping mall, each information having a goods name, a price and a plurality of detail data. The mobile terminal uses the first data communication device to send the shopping list to the second data communication device. The remote server accordingly searches the database for at least one goods information that has an identical goods name to one of the goods names in the shopping list and at least one detail data meeting with a preference condition, thereby sending the goods information to the mobile terminal for displaying on the display.

Thus, a consumer in shopping can establish the shopping list in advance. Also, a seller can supply identical goods or provide similar ones and associated data to the consumer according to consumer preferences or habits, so as to offer the consumer convenient price comparison or more type choices.

The input device is integrated into the mobile terminal to further confirm picked goods and input a personal financial account. The input device can be a keyboard, touch screen, voice recognition or other equivalent device. The microprocessor calculates a total amount for a payment of the picked goods and sends the total amount and the personal financial account from the first to the second data communication devices. Thus, the remote server deducts the total amount from the personal financial account and transfers the payment to an assigned account via a banking network.

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram of a shopping assistant system according to an embodiment of the invention;

FIG. 2 is a flowchart of a shopping assistant method according to an embodiment of the invention;

FIG. 3 illustrates a content of a shopping list according to an embodiment of the invention;

FIG. 4 illustrates a content of a server database according to an embodiment of the invention;

FIG. 5 illustrates a content of a recommendable shopping list according to an embodiment of the invention;

FIG. 6 is a schematic diagram of a goods map according to an embodiment of the invention;

FIG. 7 is a schematic diagram of a guide path according to an embodiment of the invention;

FIG. 8 illustrates a content of a newly recommendable shopping list according to an embodiment of the invention; and

FIG. 9 illustrates a content of confirmed shopping list according to an embodiment of the invention.

### DETAILED DESCRIPTION OF THE PREFERRED EMBODIMENT

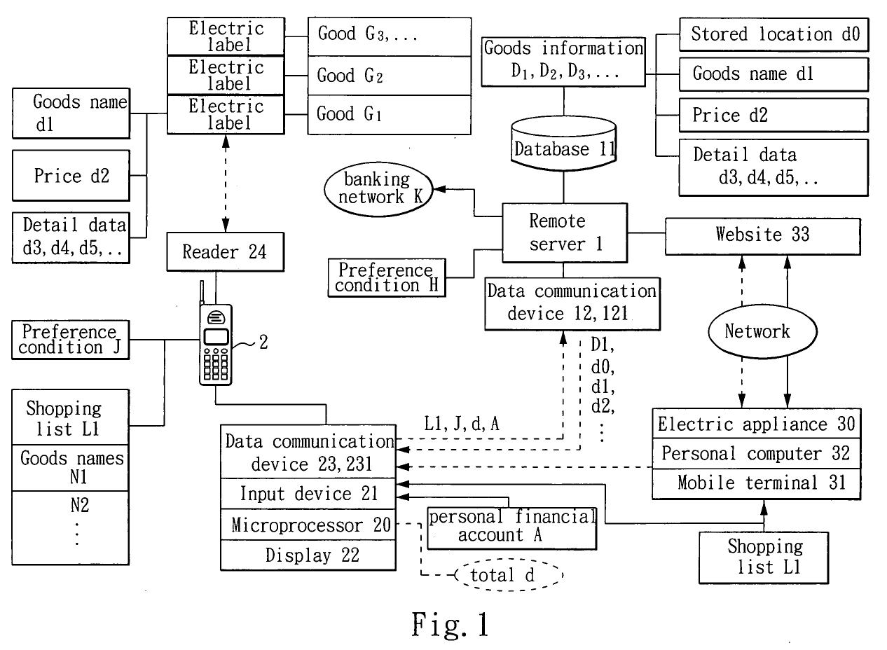

FIG. 1 is a schematic diagram of a shopping assistant system according to an embodiment of the invention. As shown in FIG. 1, the shopping assistant system is used in a shopping mall with plural goods G1, G2, G3 . . . , wherein the system includes a mobile terminal, such as a bluetooth mobile phone 2, and a remote server 1.

This embodiment directly uses a bluetooth mobile phone 2 of a consumer as the mobile terminal. The consumer requires keeping client basic information in a desk of the shopping mall for registering as a member. As such, the bluetooth mobile phone 2 can be regarded as the mobile terminal. A typical bluetooth mobile phone 2 has a microprocessor 20, an input device 21, a display 22 and a data communication device 23 consisting of a bluetooth module.

The remote server 1 is implemented in a computer room of the shopping mall and has a database 11 and a data communication device 12. The database 11 stores a plurality of goods information D1, D2, D3 . . . etc. respectively associated with selling goods G1, G2, G3 . . . etc., each goods information having a goods name d1, a price d2, a stored location d0 and a plurality of detail data d3, d4, d5 . . . etc. In addition, the device 12 can be implemented at entrance or path sides of the shopping mall. The device 12 preferably is a bluetooth wireless communication device 121 for two-way communication with the bluetooth mobile phone 2.

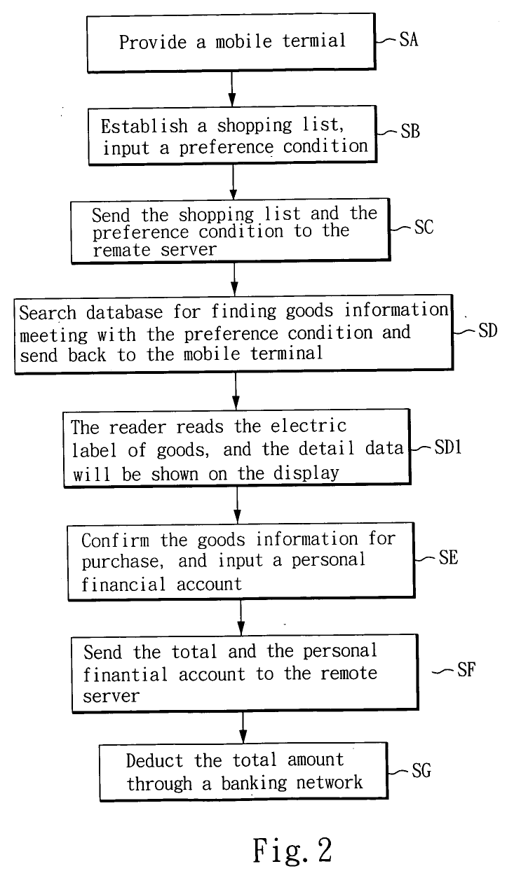

FIG. 2 is a flowchart of a shopping assistant method according to an embodiment of the invention. As shown in FIG. 2, at first, a mobile terminal, i.e., the bluetooth mobile phone, is provided to a consumer (step SA) such that the consumer can establish a shopping list L1 in the mobile terminal before arriving at the shopping mall for shopping. The shopping list L1 has goods names N1, N2 . . . etc. for shopping this time. The list L1 can be established by several ways (step SB), for example, using buttons on the input device 21 (i.e., a keyboard, touch screen or voice recognition device) to key in a content of the list L1, using a personal computer 32 at home to connect with the Website of the shopping mall through the Internet for establishing the list L1 and downloading it to the bluetooth mobile phone 2, using a stock management of a network electric appliance 30 to establish the list L1 and directly send it to the phone 2, or using another mobile terminal 31 (a PDA, mobile phone, smart phone and the like) to forward the list L1 to the phone 2.

Referring to FIG. 1 and FIG. 2, when the consumer arrives at the shopping mall, the phone 2 carried by the consumer uses its data communication device 23 (a wireless communication device 231) to login to the remote server 1 of the shopping mall at the entrance and sends the list L1 to the data communication device 12 (a wireless communication device 121) in a wireless way (step SC). Next, the server 1 identifies the consumer's identity. In addition, the consumer can edit a preference condition J in advance in step SB and send it to the remote server 1 in step SC, or the remote server 1 can establish a preference condition H according to the consumer's transactions. However, when authenticating, a simple wireless radio frequency identification (RFID) label, instead of the wireless communication device 231, can be used. In this case, an RFID reader installed at the entrance of the shopping mall can read personal identity data stored in the label to identify a respective consumer.

Next, the remote server 1 searches its database 11 according to the list L1 and the preference condition J or H for finding, for example, a goods information D1 that has an identical goods name N1 and its detail data d3, d4, d5 . . . etc. meeting with the preference condition J or H to thus form a recommendable shopping list to be sent to the phone 2 (step SD), thereby displaying the recommendable shopping list on the display 22 for further picking by the consumer.

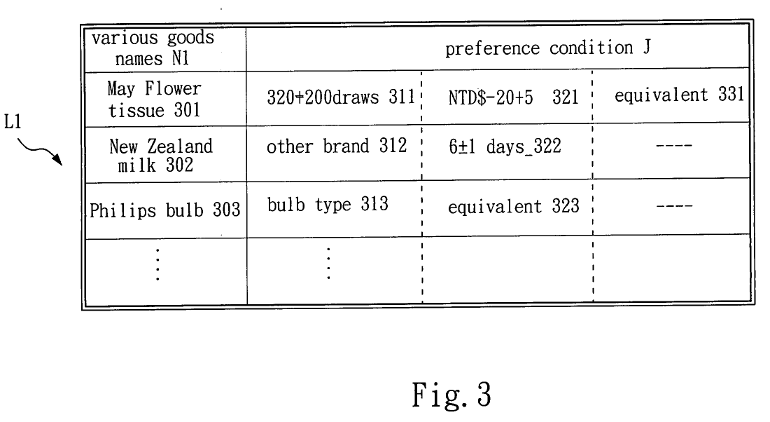

FIG. 3 illustrates an exemplary content of the shopping list L1 according to an embodiment of the invention. As shown in FIG. 3, the content of the list L1 established in advance by the consumer shows various goods names N1, N2 . . . etc., such as May Flower tissue 301, New Zealand milk 302, Philips bulb 303, and the like. The consumer produces the preference condition J according to the preferences corresponding to the goods to be purchased. For example, more than one preferences can be set to a same goods by the consumer and combined with Boolean operators, thereby forming the preference condition J. Some examples are given in FIG. 3. If the consumer wants to buy the tissue 301 with a specification of 100 to 500 draws, a price about NTD 20 or the equivalent 331, the preference condition J established has a package tolerance 311 of 300±200 draws, a price tolerance 321 of NTD 20±5 or to buy the equivalent 331 (in this case, Boolean operator “or” is used to select one of the three). In addition, if the consumer does not want to buy the milk 302 to be expired soon but can accept other brand with the same quality, the preference condition J established is an other brand 312 having the same quality and a reservation tolerance of 6+1 days 322 (in this case, Boolean operator “and” is used to meet with the two). Further, if the bulb 303 to be purchased is a special type but can accept other brand with the same type, the preference condition J established is a special bulb type 313 of 313-005A and the equivalent 323 (in this case, Boolean operator “and” is used to meet with the two).

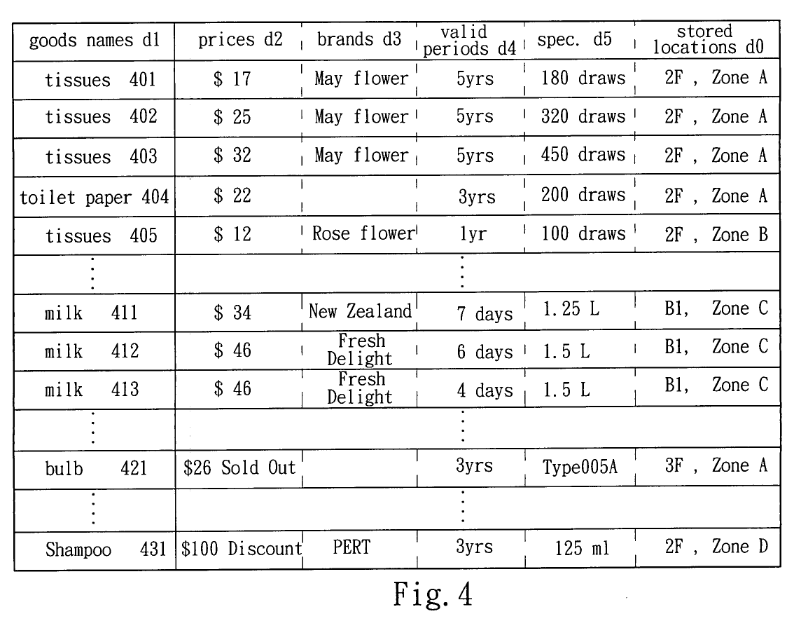

After the list L1 and the preference condition J are sent to the remote server 1, the remote server 1 directly replaces the preference condition H with the preference condition J for further shopping services. FIG. 4 illustrates a content of server database 11 according to an embodiment of the invention. As shown in FIG. 4, the database 11 stores various goods names d1 and corresponding information of prices d2, brands d3, valid periods d4, specifications d5 and stored locations d0. The remote server 1 compares the preference condition H with the database to thus find four records of tissue information, wherein Tissues 401 and 402 are sold at prices of NTD 17 and NTD 25 respectively that both meet with the price tolerance 321 of 20±5 set for the preference condition J. In addition, Tissue 403 has a specification d5 of 450 draws that meets with the package tolerance 311 of 320±200 draws set for the preference condition H. Similarly, Toilet paper 404 meets with the other goods 331 with the same quality set for the preference condition J. Accordingly, the remote server 1 sends the four records to the phone 2, thereby forming the recommendable shopping list. At this point, a brand d3 as Rose is discarded because its specification d5 indicates 100 draws and its price d2 indicates NTD 12, which both do not meet with the preference condition J.

Similarly, since the remote server 1 finds Milk 411 identical to the New Zealand milk 302 by comparison, the information of Milk 411, including its price d2, brand d3, valid period d4, specification d5 or stored location d0, is sent to the phone 2. Also, the remote server 1 finds two different types of milk, Milk 412 and 413, according to the preference condition J that both meet with the other brands 312 with the same quality, in this case, a milk brand of Fresh Delight, but by comparison of the reservation tolerance 322 set for the preference condition J, Milk 413 does not qualify. Accordingly, the remote server 1 sends only the information of Milk 412, including its price d2, brand d3, valid period d4, specification d5, stored location d0, to the phone 2, i.e., Milk 413 is not included.

For Philips bulb 303 to be purchased, the remote server 1 searches its database and finds that Bulb 421 meeting with the preference condition is to be a “Sold Out” status and no brand 323 with the same type is found. In this case, the remote server 1 informs the consumer about the “Sold Out” status of Bulb 421 and its detail data d3, d4, d5 . . . etc. via the phone 2.

In addition, the remote server 1 can pre-analyze a consumer's habits or frequencies based on the consumer's history for adding the habits in the preference H. In addition, the remote server 1 can automatically add promotion goods information in the preference H, thereby automatically offering the consumer a promoting goods information D2 for further increasing transaction opportunity. For example, the remote server 1 finds that the consumer buys shampoo once every three months when the consumer logins. In addition, the remote server 1 also finds that a price tolerance of shampoo ranges between NTD 100±20 that is typically established in the preference condition by the consumer. In this case, if shampoo is at a discount, the remote server 1 can accordingly find Shampoo 431, which meets with the price tolerance, and its detail information is automatically sent to the phone 2, thereby suggesting the consumer to buy it.

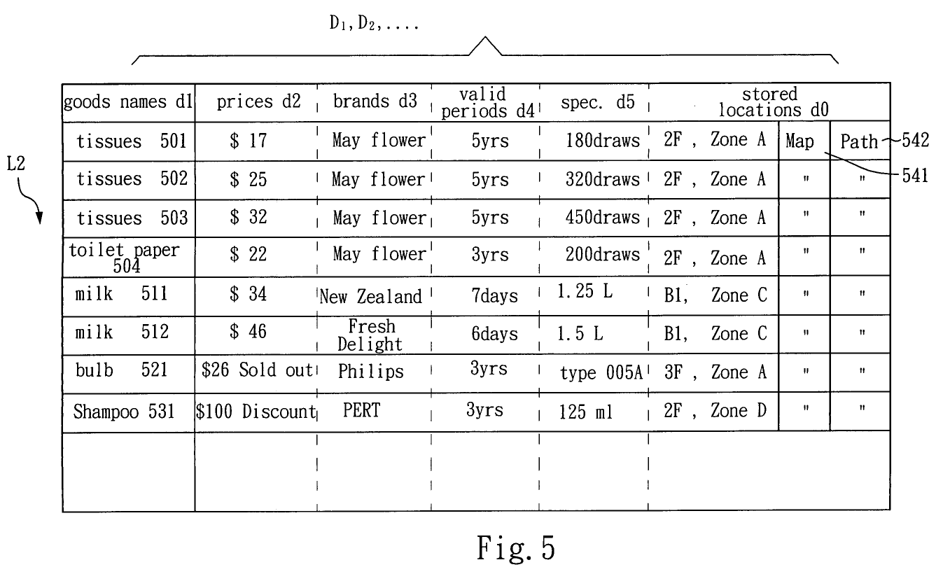

Therefore, the phone 2 carried by the consumer can receive goods information D1, D2, D3 . . . etc. provided by the remote server 1 and integrate them into a recommendable purchase list L2. FIG. 5 illustrates a content of the recommendable shopping list L2 according to an embodiment of the invention. As shown in FIG. 5, the consumer can choose one after conveniently comparing Tissue 501 to 503 of the assigned brand of May Flower and their respective prices d2 and specification (package) d5 via the phone 2. Similarly, the consumer can choose Milk 511 of New Zealand or Milk 512 of Fresh Delight. In addition, the consumer can further know PERT Shampoo 531 at a discount and 005A Bulb 521 sold out without any substitute. Accordingly, the consumer does not miss the discounted shampoo and not waste time in order to get the required bulb.

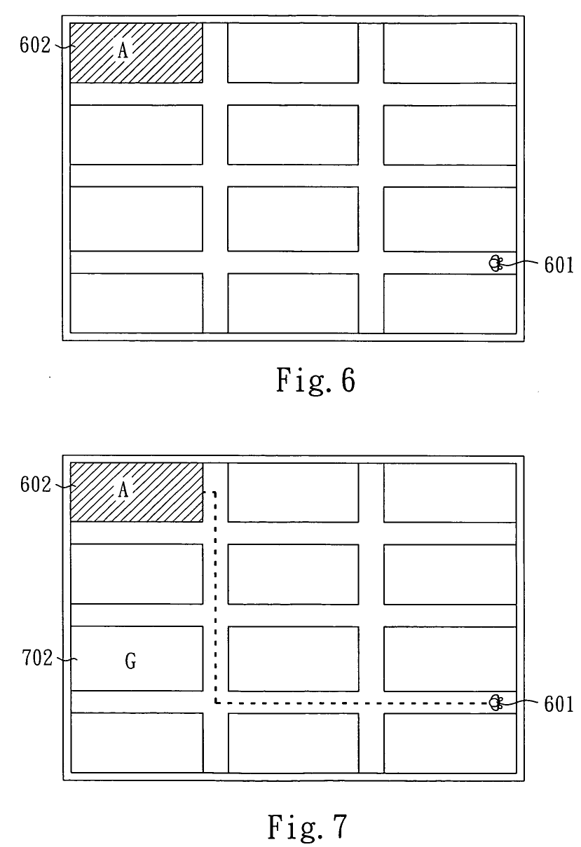

Further, the goods information D12,. D3 . . . etc. sent to the phone 2 contains information of stored location d0, for example, Tissue 501 to 503 at Zone A of Second Floor (2F) and Milk 511 and 512 at Zone C of Basement (B1). Furthermore, a map option 541 is provided for displaying the stored locations of goods G1, G2, G3 . . . etc. in the shopping mall, or a path option 542 is provided for displaying a guide path to help the consumer to quickly find the goods required. FIG. 6 is a schematic diagram of a goods map according to an embodiment of the invention, that is a plan of the second floor in the shopping mall. As shown in FIG. 6, Position 601 indicates where the consumer locates, and Zone A 602 indicates a position where Tissue 501 locates. As such, the consumer can definitely know that his/her position corresponds to the position of Tissue 501. FIG. 7 is a schematic diagram of a guide path according to an embodiment of the invention. As shown in FIG. 7, the remote server 1 further provides a guide path 701 for guiding the consumer moving from Position 601 to Zone A 602 such that the consumer can quickly find the required goods, Tissue 501.

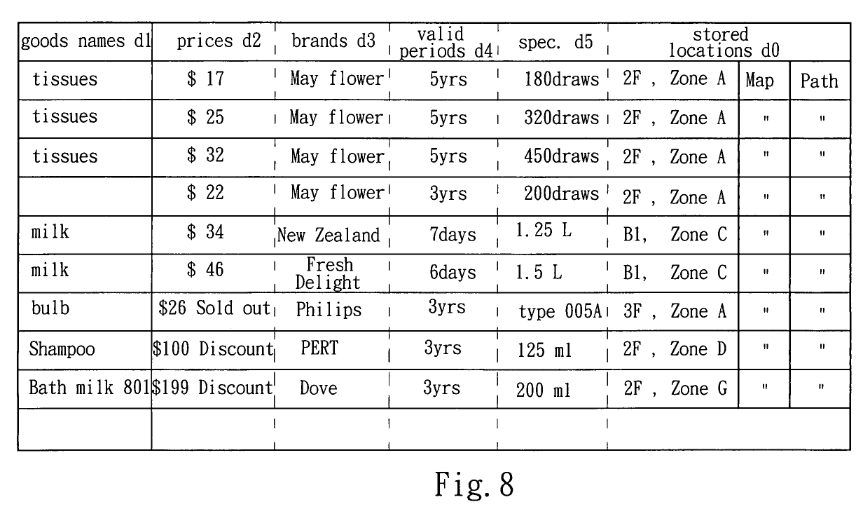

In addition, each goods G1, G2, G3 . . . etc. sold in the shopping mall can further have an electronic identification label, which stores corresponding goods name d1, price d2 and detail data d3, d4, d5. . . . etc. The consumer can pre-store a preference condition J (the same as the preference condition H stored in the remote server) in the phone 2 and add a reader 24 (such as an RFID reader, bluetooth reader, barcode reader and the like) to read an electronic label of goods G3 on the shelve. The microprocessor 20 of the phone 2 displays the content of electronic label of goods G3 on the display 22 of the phone 2 (SD1) when the detail data of goods G3 meets with the preference condition J. Referring again to FIG. 7, if the consumer set the preference condition J to an original price minus NTD 50, when the consumer passes Zone G 702, a Dove bath milk sold in Zone G is discounted from NTD 239 to NTD 199, which meets with the preference condition J and is provided to the phone 2 for displaying on the display 22. FIG. 8 illustrates a content of a newly recommendable shopping list according to an embodiment of the invention. As shown in FIG. 8, in this case, Bath Milk 801, i.e., the Dove bath milk, and associated data is further added in the list L2 for the consumer's reference and purchase.

Therefore, the consumer can pre-establish the shopping list, and the seller can supply identical goods or provide similar ones and associated data to the consumer according to consumer preferences or habits, so as to offer the consumer convenient price comparison or more type choices.

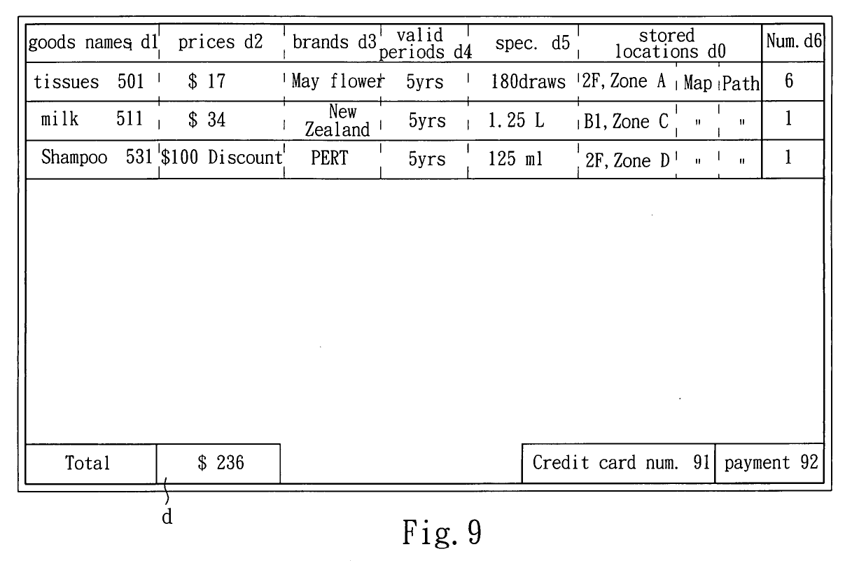

When shopping, the consumer uses the input device 21 to confirm the goods information D1, D2, D3 . . . etc. for purchase to thus form a confirmed shopping list, and inputs a personal financial account A for payment after the microprocessor 20 of the phone 2 sums up a total d of the confirmed shopping list (step SE). FIG. 9 illustrates a content of the confirmed shopping list displayed on the phone 2 according to an embodiment of the invention. As shown in FIG. 9, after the consumer determines goods information and corresponding quantities d6 to be purchased, the microprocessor 20 calculates the total amount d as NTD 236. Next, the consumer inputs a credit card number 91 (personal financial amount A) and chooses a payment option 92 to thus send the total amount d and the card number 91 to the device 121 through the device 231 (step SF). Next, the remote server 1 deducts the total amount from the credit card account 91 for transfer through a banking network K (step SG), thereby completing a desired electronic transaction. The embodiment can combine with a backend account transfer/deduction mechanism to offer the consumer a convenient shopping and auto-payment banking service.

Although the present invention has been explained in relation to its preferred embodiment, it is to be understood that many other possible modifications and variations can be made without departing from the spirit and scope of the invention as hereinafter claimed.

What is claimed is:

1. A shopping assistant method, which is used in a shopping mall that sells plural goods, comprising the steps:
(A) providing a mobile terminal to be portable in a shopping mall;
(B) establishing a shopping list in the mobile terminal, the shopping list having at least one goods name to be purchased;
(C) sending the shopping list from the mobile terminal to a remote server with a database, the database storing a plurality of goods information associated with selling goods available in the shopping mall, each goods information having a goods name, a price and at least one detail data; and
(D) searching the database for the goods, thereby finding a goods information with goods name identical to the goods name in the shooping list and at least one detail data meeting with a preference condition and then sending the goods information found to the mobile terminal for displaying the identical goods name and its price at least.

2. The method as claimed in claim 1, further comprising the steps:
(E) using the mobile terminal to confirm the goods information found, sum up a total amount based on the goods information found, and input a personal financial account;
(F) using the mobile terminal to send both the total amount and the personal financial account to the remote server; and
(G) using the remote server to deduct and transfer the total amount from the personal financial account through a banking network for payment.

3. The method as claimed in claim 2, wherein the personal financial account is one selected from a credit card account, an electronic wallet account and an electronic coupon number.

4. The method as claimed in claim 1, wherein the at least one detail data and the preference condition are one or more selected from:
(1) a package of a goods and a package tolerance;
(2) a brand of the goods and an other brand having the same quality as the brand;
(3) a price of the goods and a price tolerance;
(4) a reservation period of the goods and a reservation tolerance; and
(5) the goods and an other goods having the same quality as the goods.

5. The method as claimed in claim 1, wherein the preference condition is established by one as follows:
(1) pre-storing the preference condition in the remote server; and
(2) inputting the preference condition in step (B) and sending it to the remote server in step (C).

6. The method as claimed in claim 1, wherein the goods information stored in the database further comprises an information of stored locations of the selling goods available in the shopping mall, and the information of stored locations is displayed on the mobile terminal in the step (D).

7. The method as claimed in claim 1, wherein in the step (B), the shopping list is established in the mobile terminal by one as follows:
(1) using a network electric appliance to establish the shopping list and sending it to the mobile terminal;
(2) using a different mobile terminal to send the shopping list to the mobile terminal;
(3) using a personal computer to link the Internet for browsing a Website established by the shopping mall in order to establish the shopping list by click and send it to the mobile terminal; and
(4) using an input device of the mobile terminal to directly input the shopping list.

8. The method as claimed in claim 1, wherein the mobile terminal is one selected from: a personal digital assistant (PDA), a mobile phone, a smart phone and a web pad.

9. The method as claimed in claim 1, wherein in the step (C) the mobile terminal uses a wireless communication device to send the shopping list to the remote server in a wireless way.

10. The method as claimed in claim 1, wherein each selling goods available in the shopping mall further adds an electronic identification label containing a respective goods name, price and at least one detail data, the mobile terminal further comprises a reader and pre-stores a different preference condition, and the step (D) further comprises a step (D1):
using the reader to read all electronic identification labels of the selling goods available in the shopping mall for comparison and thus finding a desired label with at least one detail data meeting with the different preference condition, thereby displaying a content of the desired label on the mobile terminal.

11. The method as claimed in claim 10, wherein the electronic identification label is one selected from: a radio frequency identification (RFID) label, a bar code, a magnetic stripe and an IC card.

12. A shopping assistant system, which is used in a shopping mall that sells plural goods, the system comprising:
at least one mobile terminal having a microprocessor, a display and a first data communication device and storing a shopping list with at least one goods name to be purchased; and
a remote server having a database and a second data communication device, the database storing a plurality of information associated with selling goods available in the shopping mall, each information having a goods name, a price and at least one detail data;
wherein the mobile terminal uses the first data communication device to send the shopping list to the second data communication device, the remote server accordingly searches the database for the goods in order to find a goods information with goods name identical to the goods name in the shopping list and at least one detail data meeting with a preference condition, thereby sending the goods information found to the mobile terminal for at least displaying the goods name identical and its price on the display.

13. The system as claimed in claim 12, wherein the mobile terminal further comprises an input device to confirm the goods information found for purchase and input a personal financial account such that after the microprocessor sums up a total amount based on the goods information confirmed, the first data communication device sends both the total amount and the personal financial account to the second data communication device to further deduct the total amount from the personal financial account for payment.

14. The system as claimed in claim 13, wherein the personal financial account is one selected from a credit card account, an electronic wallet account and an electronic coupon number.

15. The system as claimed in claim 12, wherein the at least one detail data and the preference condition are one or more selected from:
(1) a package of a goods and a package tolerance;
(2) a brand of the goods and an other brand having the same quality as the brand;
(3) a price of the goods and a price tolerance;
(4) a reservation period of the goods and a reservation tolerance; and
(5) the goods and an other goods having the same quality as the goods.

16. The system as claimed in claim 12, wherein the preference condition is established by one as follows:
(1) pre-storing the preference condition in the remote server; and
(2) using the input device to input the preference condition and send it to the remote server.

17. The system as claimed in claim 12, wherein the goods information stored in the database further comprises an information of stored locations of the selling goods available in the shopping mall, and the information of stored locations is displayed on the display.

18. The system as claimed in claim 12, wherein the shopping list stored is established in the mobile terminal by one as follows:
(1) using a network electric appliance to establish the shopping list and sending it to the mobile terminal;
(2) using a different mobile terminal to send the shopping list to the mobile terminal;
(3) using a personal computer to link the Internet for browsing a Website established by the shopping mall in order to establish the shopping list by click and send it to the mobile terminal; and
(4) using an input device of the mobile terminal to directly input the shopping list.

19. The system as claimed in claim 12, wherein the mobile terminal is one selected from: a personal digital assistant (PDA), a mobile phone, a smart phone and a web pad.

20. The system as claimed in claim 12, wherein the first and second data communication devices are wireless communication devices.

21. The system as claimed in claim 12, wherein each selling goods available in the shopping mall further adds an electronic identification label containing a respective goods name, price and at least one detail data, the mobile terminal further comprises a reader and pre-stores a different preference condition, such that the mobile terminal uses the reader to read all electronic identification labels of the selling goods available in the shopping mall for comparison and thus finding a desired label with at least one detail data meeting with the different preference condition, thereby displaying a content of the desired label on the display.

22. The system as claimed in claim 21, wherein the electronic identification label is one selected from: a radio frequency identification (RFID) label, a bar code, a magnetic stripe and an IC card.
